(19) United States
(12) Patent Application Publication
(10) Pub. No.: US 2015/0373912 A1
(43) Pub. Date: Dec. 31, 2015

(54) BALE CLAMP

(71) Applicant: RAXEL PTY LTD, Cowra, New South Wales (AU)

(72) Inventor: Phillip D. Wallace, Cowra, New South Wales (AU)

(73) Assignee: RAXEL PTY LTD, Cowra, New South Wales (AU)

(21) Appl. No.: 14/768,498

(22) PCT Filed: Mar. 11, 2014
(86) PCT No.: PCT/AU2014/000234

§ 371 Date: Aug. 18, 2015

(30) Foreign Application Priority Data
Mar. 11, 2013 (AU) 2013900829

(51) Int. Cl. A01D 87/00; A01D 87/12

(52) U.S. Cl. CPC A01D 87/003; A01D 87/122

(57) ABSTRACT

A bale clamp comprises at least one actuator. The bale clamp also comprises at least two clamp members and at least one protruding portion extending from each clamp member. At least one of the protruding portions is configured such that, in use, it may be inserted into a bale. At least one of the clamp members can be caused by the actuator to move relatively towards the other clamp member(s) such that at least part of the bale can be secured between the protruding portions of the clamp members.

### TECHNICAL FIELD

A bale clamp is disclosed for lifting, moving and general handling of bales. The bale clamp is adjustable for handling bales and portions of bales having various sizes and shapes.

### BACKGROUND ART

Bale handlers are often employed in, but not limited to, a variety of agricultural activities and in particular are often used in the handling of, for example, hay bales, wool bales, cotton bales, etc.

Bale handlers can consist of two or more spikes fixedly mounted onto a frame such that, in use, the spikes are inserted into a bale so that it may be handled. Such bale handlers require that the bales be constrained by ties or straps, such that when the bale is handled the bale does not break up. In order for a bale to be released from these bale handlers into e.g. a grinder, the ties or straps must be cut. If the bale is, for example, raised above the ground (i.e. above the grinder), a worker must climb on to the bale in order to cut the ties, risking serious or potentially fatal injury.

Also known in the art are bale clamps that are configured so that a bale may be clamped at its ends. For example U.S. Pat. No. 8,016,334 discloses a bale handling device, comprising hydraulic cylinders configured to move a pair of opposing plates, such that the plates clamp opposing ends of a bale, allowing it to be handled.

The above references to the background art do not constitute an admission that the art forms part of the common general knowledge of a person of ordinary skill in the art. The above references are also not intended to limit the application of the bale clamp and method for handling a bale as disclosed herein.

### SUMMARY OF THE DISCLOSURE

Disclosed herein is a bale clamp. The bale clamp finds particular, though not exclusive, application in agriculture for handling bales of, for example, hay, wool, cotton, etc.

The bale clamp comprises a support frame and two clamp members. Each clamp member comprises a protruding portion and a support arm mounting the clamp member to the support frame and arranged for sliding movement along a longitudinal sliding axis of the support arm in a lateral direction with respect to the support frame. The longitudinal sliding axis of each support arm is offset to the longitudinal sliding axis of each other support arm. The bale clamp further comprises an actuator (e.g. a hydraulic, electro-mechanical, mechanical or pneumatic actuator) supported on the support frame. The actuator is arranged such that at least one of the clamp members can be caused by the actuator to move relatively towards the other clamp member to secure at least part of the bale between the protruding portions of the clamp members. At least one of the protruding portions is configured such that, in use, it may be inserted into a bale to facilitate handling of the bale.

In contrast to the bale clamp disclosed in U.S. Pat. No. 8,016,334, at least one of the protruding portions is configured such that, in use it may be inserted into a bale. This allows a user to pick up either a portion of a bale, a whole bale or multiple bales. For example, if a user wishes to handle half of a bale, the user may position the bale clamp such that one clamp member's protruding portion(s) is located at the end of the bale and another clamp member's protruding portion(s) is inserted into the bale and e.g. halfway along the bale from that end. Actuation of the actuators may then allow the e.g. half bale to be compressed between the protruding portions so that it may be secured by the bale clamp, leaving the remaining portion of the bale behind.

Having at least one protruding portion configured to be inserted into a bale may mean that minimal disturbance is caused to the structure of the bale upon insertion of the protruding portion. Further, when inserting the protruding portion into the bale, the bale may not be pushed by the protruding portion away from the bale clamp.

In use, the at least two clamp members may be located such that their respective protruding portions are positioned at opposing ends and/or sides of a bale or a bale portion. The at least one actuator can then be actuated such that the bale is compressed between the protruding portions. This compression force may be large enough such that the bale may be moved and/or lifted without it breaking apart. This may mean that any ties, straps etc. located around the bale may be removed prior to handling of the bale by the bale clamp. For example, if the bale has been lifted above e.g. a grinder, there is no need for a user to first remove the straps, ties, etc. around the bale in order to release the bale into the grinder.

In one embodiment at least one of the protruding portions may be configured to be inserted into a bale by providing a taper therein which tapers inwardly towards a distal end of the protruding portion. The smaller cross-sectional area of the distal end may allow easier insertion of the protruding portion into a bale, whilst the larger cross-sectional area at the base of the protruding portion may provide a stronger structure at its joint (i.e. where there may be stress concentrations) with the clamp member. The protruding portion may, for example, be in the form of a spike, having a circular cross-section, or alternatively, may be in the form of a wedge having a rectangular cross-section. It would be understood by a person of ordinary skill in the art that the protruding portion may take any form suitable for insertion into a bale. Any number of the protruding portions may be configured for bale insertion, such as by being tapered.

For example, one clamp member may comprise a protruding portion having a non-tapered surface suitable for association with an end surface of a bale, whilst one or more other clamp members may each comprise one or more protruding portions configured (e.g. tapered) for insertion into the bale. This combination may suit a bale clamp specifically configured for handling bale portions.

In one embodiment, each of the protruding portions may be tapered towards its distal end. In this case, the bale clamp may be used as a traditional bale handler, for example, when the actuator is not active. In this case, the user may choose not to remove any restraints around the bale and may then choose to insert all of the tapered protruding portions into the bale so that it may be handled. Thus, the bale clamp may still function as a traditional bale handler in the absence of any actuation of the actuator (e.g. if there is no power to the actuator). The user therefore may have the option of disconnecting the actuator if it is not required for a job or if incompatible with a vehicle the bale clamp is mounted to.

However, where each of the protruding portions is tapered, the bale clamp can still be used, as set forth above, with an active actuator such that a bale or bale portion can be secured between the tapered protruding portions for handling.

As set forth above, each clamp member comprises at least one support arm that is mounted for sliding movement along a longitudinal axis of the at least one support arm and in a lateral direction with respect to the support frame. The support arm may be in the form of, for example, a tubular steel member (e.g. of square, rectangular or circular hollow section).

In one embodiment the support frame may comprise a track for each support arm, to facilitate the sliding movement of a respective support ann. The track may be formed such that the support arm fits snugly within the track. For example, if the support arm has a square cross section, the track may have a similar, albeit slightly larger, square cross section.

The tracks may be defined by, for example, elongate C-section which may also be mounted in a back-to back (i.e. web-to-web) configuration in the support frame. Alternatively, the tracks may be defined by one or more I-beams mounted in the support frame. In each case, a support arm can slide in and be supported by a channel of the C-section or I-beam.

In another alternative configuration, the tracks may be in the form of rails and, when the support arms are hollow, the rails may be snugly located in the hollow interior of the support arms to support the sliding lateral movement of the support arms.

In one embodiment the longitudinal axis of a given arm may be offset to the longitudinal axes of each other arm. This may ensure that the paths of motion of the support arms do not intersect. Further, this arrangement may allow opposing clamp members to be moved apart, such that the gap between the protruding portions on respective clamp members is larger than the width of the support frame (i.e. the clamp members may extend beyond the edges of the support frame). In contrast, due to the configuration of the bale clamp in U.S. Pat. No. 8,016,334, its clamp members (i.e. forks) are unable to extend beyond the limits of the support frame (i.e. rails). This same arrangement may also allow the clamp members to be moved towards each other such that the there is minimal or no distance between the protruding portions of each clamp member.

In one embodiment the support arms may be arranged to slide in a single plane. The support arms may, for example, may be arranged such that they are located in adjacent tracks located on the support frame. The single plane may extend generally vertically in use.

In one embodiment each clamp member may be actuated by a corresponding actuator. Each actuator may comprise a hydraulic cylinder. Alternatively, each actuator may be an electro-mechanical or mechanical linear actuator whereby rotation from an electric or mechanical motor is converted into linear motion via a gear system. The actuator may alternatively be a pneumatic actuator. It would be understood by a person of ordinary skill in the art that the actuator may comprise any arrangement suitable for inducing linear motion in a clamp member.

In one embodiment the bale clamp may be configured for attachment to a vehicle. The vehicle may be, for example, a fork lift, a truck, a tractor or any other vehicle suitable for attachment of a bale clamp. The term vehicle means any agricultural, mining or industrial machinery that may be used in conjunction with a bale clamp.

Also disclosed herein is a bale clamp for handling bales. The bale clamp comprises an actuator and at least two clamp members. Each clamp member has a support arm for supporting and enabling lateral movement of the clamp member. Each support arm has a longitudinal axis along which the support arm travels during the lateral movement. One or more of the clamp members comprises a protruding portion configured such that, in use, it may be inserted into the bale to facilitate handling of the bale. An axis of any given arm may be offset with respect to the axis of each other arm. As set forth above, this arrangement may allow the clamp members to extend beyond the edges of the support frame and may also allow the clamp members to be moved together so that there is minimal or no distance between their protruding portions.

The protruding portion may be configured to be inserted into the bale by providing a taper therein which tapers inwardly towards a distal end of the protruding portion. In another embodiment, each protruding portion may be configured for bale insertion (e.g. tapered towards its distal end). In one embodiment one or more of the clamp members may comprise a plurality of protruding portions.

In one embodiment the bale clamp may further comprise a support frame for the actuator and the support arms of the at least two clamp members. The support frame may be configured to support the relative movement of the clamp members. The support frame may comprise a track for each support arm to facilitate the sliding movement of the support arm. The support arms may be arranged in a single plane and the single plane may extend generally vertically in use.

In one embodiment the bale clamp may comprise a plurality of actuators. Each clamp member may be actuated by a corresponding actuator. In another embodiment the or each actuator may be a hydraulic cylinder.

In one embodiment the bale clamp may be configured for attachment to a vehicle.

Also disclosed herein is a vehicle comprising the bale clamp as set forth above. The bale clamp may be permanently mounted to the vehicle. For example, if the bale clamp is metal, it may be welded directly to the vehicle or alternatively, if the bale clamp comprises e.g. carbon fibre, it may be permanently mounted to the vehicle by way of a suitable adhesive. The bale clamp may otherwise be temporarily mounted to the vehicle. For example, when present, the support frame may comprise hook features for engagement to a corresponding support feature on the vehicle. Alternatively, the bale clamp may be fastened by bolts, screws, rivets, etc. to the vehicle. It would be understood by a person skilled in the art that the bale clamp may be mounted to the vehicle by other suitable temporary or permanent mounting arrangement.

Also disclosed herein is a method of handling a bale portion using a bale clamp as set forth above. The method comprises moving the clamp members to a desired width and inserting a protruding portion of the clamp member into the bale. The method further comprises moving relatively one or more of the clamp members towards each other such that part of the bale, corresponding to the desired width, can be secured between the protruding portions of the clamp members.

Also disclosed herein is a method for handling a bale. The method comprises inserting a protruding portion of a clamp member into the bale, positioning the protruding portion of an opposing clamp member adjacent to a side of the bale, and moving relatively one or more of the clamp members towards each other such that part of the bale can be secured between the protruding portions of the clamp members.

In one embodiment the method may further comprise the step of moving the part of the bale away from the bale, once the part of the bale is secured between the protruding portions.

In one embodiment the clamp members may be moved by one or more actuators.

In one embodiment one or more of the clamp members may comprise a plurality of protruding portions.

In one embodiment one or more of the protruding portions are tapered inwardly to a distal end thereof.

### BRIEF DESCRIPTION OF THE DRAWINGS

Notwithstanding any other forms which may fall within the scope of the bale clamp and method as set forth in the Summary, specific embodiments will now be described, by way of example only, with reference to the accompanying drawings in which:

FIGS. 1A and B show a first embodiment of the bale clamp in open and closed positions.

FIG. 1C shows a second embodiment comprising a wedge protruding portion extending from one of the clamp members.

FIG. 1D shows a third embodiment having only one actuator and wherein each clamp member has three protruding portions.

FIGS. 2A and 2B shows the first embodiment of the clamp member in use.

FIG. 3 shows the first embodiment of the clamp member mounted to a forklift.

### DETAILED DESCRIPTION OF SPECIFIC EMBODIMENTS

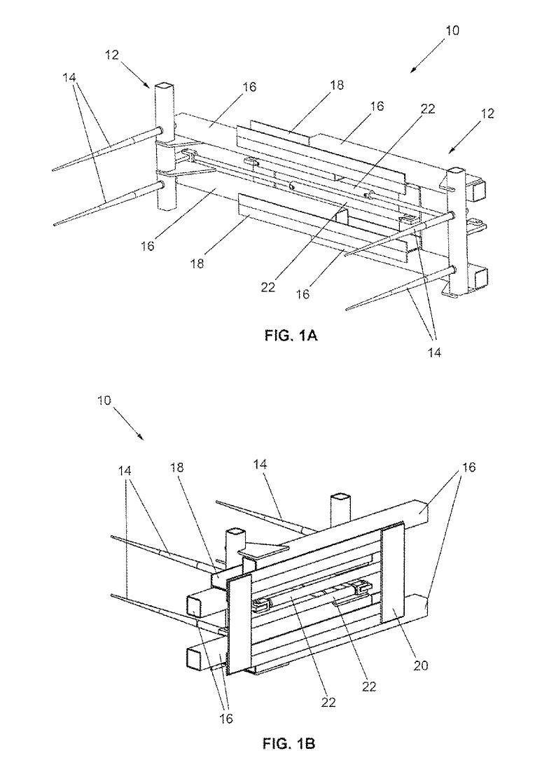

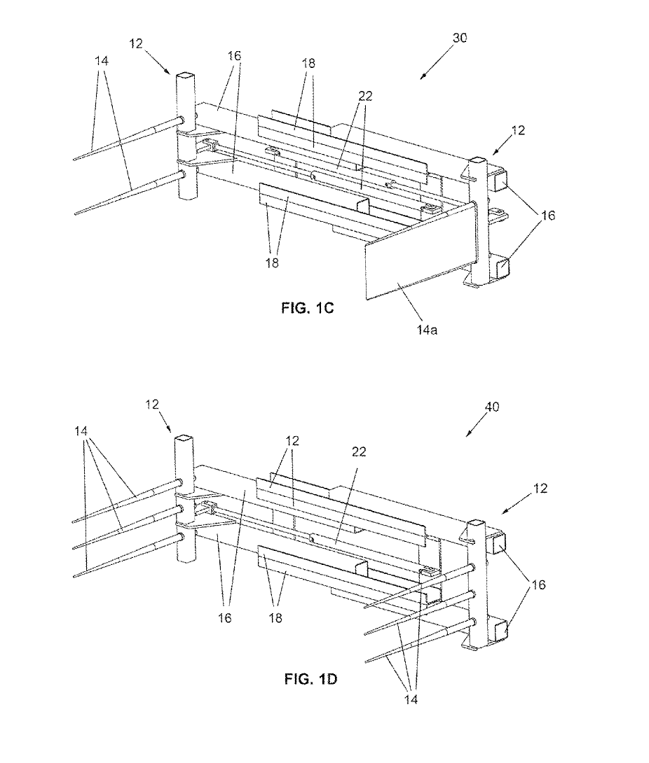

Referring firstly to FIG. 1A and B, a first embodiment of the bale clamp 10 is shown. The bale clamp 10 comprises two clamp members 12, each clamp member 12 having two protruding portions 14 extending therefrom. In this embodiment, the clamp member is formed from an assembly of tubular and plate steel parts that are welded together.

However, each clamp member 12 is not restricted to having two protruding portions 14 and can have any suitable number of protruding portions 14. For example in FIG. 1C a second embodiment of a bale clamp 30 is shown, wherein one clamp member 12 has a single protruding portion 14a and the other clamp member has two protruding portions. In FIG. 1D a third embodiment is shown of a bale clamp 40 having two clamp members 12, each comprising three protruding portions 14.

The protruding portions 14, in the first and third embodiments are in the form of steel spikes 14 having circular cross-sections. These spikes 14 are mounted to the clamp members 12 by way of a nut and bolt arrangement. However, the protruding portions 14 are not limited to being in the form of spikes 14, and may for example be in the form of a wedge 14a as is shown in FIG. 1C. The wedge 14a may also provide a suitable surface for supporting the end of a bale. For example, the wedge 14a may be placed at the end of a bale, and the spikes 14, placed into a central portion of the same bale. The wedge 14a and spikes 14, may then be moved towards each other by the hydraulic cylinders 22 so that the portion of the bale between the wedge 14a and spikes 14 may be handled by the bale clamp 30. The wedge 14a can also be inserted into the bale.

The arrangement of the bale clamp is such that, in the case that actuator 22 is unable to actuate (e.g. it is disconnected from its power source or has malfunctioned), the bale clamp 10 may still be used as a traditional bale handler by leaving a bale secured by ties or straps and inserting all of the spikes 14, wedge 14a into the bale for handling.

Each clamp member further comprises support arms 16 which are mounted in corresponding tracks 18, located on a support frame 20. The tracks 18, in this embodiment, are in the form of C-shaped channels mounted in a back-to back (i.e. web-to-web) configuration. However it would be understood by a person of ordinary skill in the art that the tracks 18 and support arms 16 may take other suitable forms, whereby the support arms 16 are supported for lateral movement along their respective tracks 18. For example, the tracks could be in the form of I-beams mounted on the support frame.

The support frame 20 may be permanently attached to a vehicle such as e.g. a forklift by welding the support frame 20 to the forklift. In other embodiments, the support frame 20 may comprise structural features such as hooks and/or holes for either temporary or permanent attachment to a vehicle, via bolts, rivets, screws, adhesives, etc.

The tracks 18 are arranged such that they are parallel to each other, although may be otherwise offset. The support arms 16 of one clamp member 12 are arranged such that they engage the two outer tracks 18, whilst the support arms 16 of the other clamp member 12 are arranged such that they engage the two inner tracks 18.

The bale clamp embodiments 10, 30 shown in FIG. 1A, B and C each further comprise two actuators in the form of hydraulic cylinders 22. Each hydraulic cylinder 22 comprises a ram and a cylinder, whereby the cylinder is attached to, and supported by, the support frame 20 and the ram is attached at its distal end to one of the two clamp members 12. However, the bale clamp 40 shown in FIG. 1D configured so as to comprise a single actuator 22 for actuating only one of the two clamp members 12. In this embodiment, the clamp member 12 that is not actuated by the actuator 22 can be fixedly attached to the support frame 20 such that it does not move with respect to the support frame 20. Such an arrangement may have less moving parts than a bale clamp with multiple actuators, and therefore may be cheaper to manufacture and/or maintain.

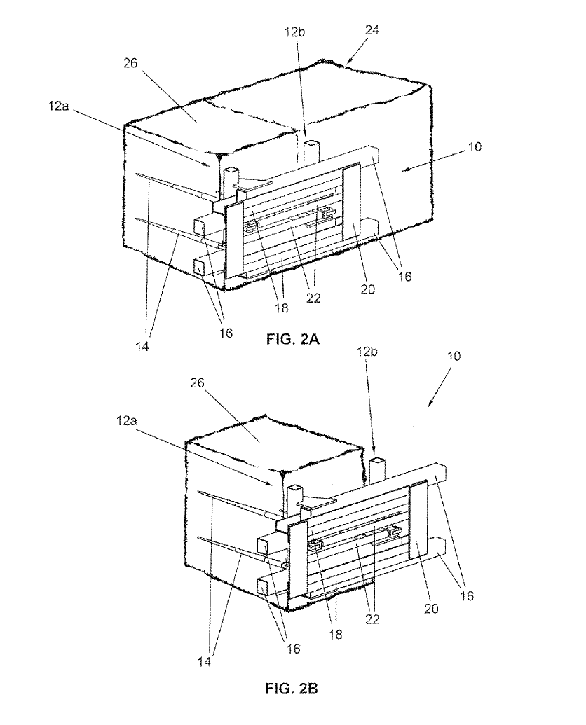

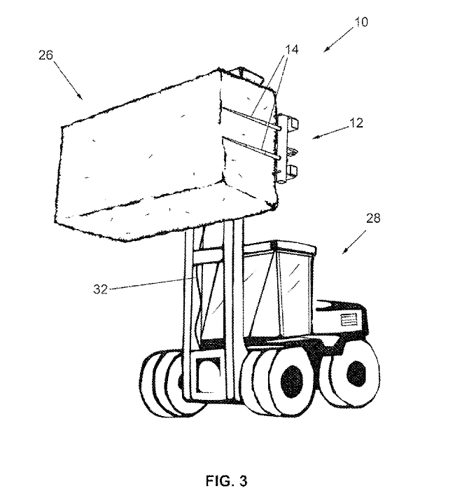

Referring now to FIGS. 2A and 2B, the first embodiment of the bale clamp 10 is shown in use. In FIG. 2A, a first clamp member 12a is aligned with an end of a hay bale 24, whilst a second clamp member 12b is aligned with a central portion of the bale 24. The protruding portions 14 of the first clamp member 12a are parallel to an end surface of the bale 24, whilst the protruding portions 14 (not visible in these figures) of the second clamp member 12b have been inserted into the bale 24. Such an arrangement means that a portion 26 of the bale 24 is located between the protruding portions 14 of the first and second clamp members 12. In order to align the bale clamp 10 in this way, the actuators 22 have been actuated, such that the clamp members 12 have moved towards each other, thereby reducing the gap between the protruding portions 14 of the clamp members 12. In this way, a bale portion 26 of any size (within the limits of the bale clamp 10) may be removed from the bale 24. Alternatively, the actuators 22 may be actuated to extend the clamp members 12, such that their protruding portions 14 are positioned at opposing ends of the bale 24. In this way, the entire bale 24 may be secured between the protruding portions 14 and handled by the bale clamp 24.

In FIG. 2B the bale portion 26 has been removed from the hay bale 24. Prior to doing so, the actuators 22 have been actuated to further move the clamp members 12 towards each other, thereby compressing the bale portion 26 between the protruding portions 14 of the clamp members 12. This compression force helps to secure the bale portion 26 between the protruding portions 14. The bale portion 26 can then be handled by the bale clamp 10 and removed from the bale 24.

It should be noted that, for clarity, a vehicle on which the bale clamp is mounted has been omitted from FIGS. 2A and B. For example, support 20 may be temporarily or permanently fixed mounted to e.g. a forklift. When the bale portion 26 is secured between the protruding portions 14, the bale clamp 10 may be lifted by the e.g. forklift away from the bale 24, such that the bale portion 26 is removed from the rest of the bale 24. Alternatively the bale clamp 10 may be fixed to the front of a truck, such that when the bale portion 26 is secured in the bale clamp 10 and the truck reverses away from the bale 24, the portion of the bale 26 is removed.

Referring now to FIG. 3, an embodiment is shown, whereby a bale clamp 10 is mounted to a forklift 28. A bale 26 is secured between the protruding portions 14 of opposing clamp members 12. The bale clamp 10 is mounted to the forklift such that it can be moved in a vertical direction. Alternatively, the bale clamp 10 may be mounted in such a way that it can also be moved in a horizontal direction for e.g. stacking purposes. The actuators on the bale clamp 10 are controlled via pipe 32, which may contain, for example, hydraulic fluid under pressure.

The bale 26 is raised above the ground and, for example, may be positioned above a grinder. The bale 26 is secured between the protruding portions 14, such that straps or ties are not required to prevent the bale from falling apart. When the bale is moved to above e.g. a grinder, the clamp members 12 can be actuated away from each other such that the bale 26 is allowed to fall into the grinder for processing. In this way, a worker is not required to climb on to the bale in order to release e.g. straps or ties so that the bale may fall into, for example, a grinder.

Whilst a number of bale clamp and operating method embodiments have been described, it should be appreciated that the bale clamp and method may be embodied in many other forms.

For example, whilst components of the bale clamp as described above are generally formed from steel members, a person of ordinary skill in the art would understand that any suitable material may be used for the components of the bale clamp. The components of the bale clamp are not restricted to a single material, and may be formed of different materials. For example, the clamp members and support arms may be formed of carbon fibre for circumstances where a lightweight structure may be preferred. Similarly, the protruding portions may have a steel core, with a coating material that may be especially selected for its durability.

Whilst the bale clamp may have more than two clamp members and, for example, may comprise an additional two clamp members for clamping in a vertical direction. The bale clamp is not limited to an even number of clamp members, and may for example comprise three or five clamp members, arranged in triangular or pentagonal configurations respectively, such that they can move towards a common point.

Clamp members may also move along skewed axes for e.g. round or circular bales. In this case, the tracks on the support frame may not be aligned parallel to each other in order to support this movement along a skewed axis.

Furthermore, whilst the protruding portions have been described in the form of spikes and wedges, the protruding portions may have any suitable form. Not all of the protruding portions must be configured to be inserted into a bale. For example, a clamp member may comprise one protruding portion for insertion into a bale and another protruding portion configured to be positioned under the bale to provide vertical support to the bale (e.g. against dropping).

Similarly the tracks for supporting the support arms of the clamp members may comprise, for example, rails whereby the support arms are able to engage with and slide over the top of the rails. Alternatively, the tracks may completely surround their respective support arms. Each support arm may have a circular cross-section and each corresponding track may be in the form of a tube, such that the support arm may slide telescopically within the tube. The tracks may also comprises bearings or rollers to facilitate sliding of the support arms.

It is not required that the actuator be a hydraulic system and, for example, each actuator may be an electro-mechanical or mechanical linear actuator whereby rotation from an electric or mechanical motor is converted into linear motion via a gear system. The actuator may alternatively be a pneumatic actuator. It would be understood by a person of ordinary skill in the art that the actuator may comprise other arrangements suitable for inducing linear motion in a clamp member.

In the embodiments described above, the bale is a hay bale, however the bale clamp is not limited to use with a hay bale and may be configured for use with e.g. a wool bale, cotton bale, wire bale, cardboard, recycling waste, etc.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the bale clamp or method for handling a bale as disclosed herein.

1-28. (canceled)

29. A bale handling clamp, comprising:
a support frame;
two clamp members, each clamp member comprising:
a protruding portion; and
a support arm mounting the clamp member to the support frame and arranged to slide along a longitudinal sliding axis of the support arm in a lateral direction with respect to the support frame, the longitudinal sliding axis being offset to the longitudinal sliding axis of the support arm of the other clamp member; and
an actuator supported on the support frame, the actuator arranged such that at least one of the clamp members is caused by the actuator to move relatively towards the other clamp member to secure at least part of the bale between the protruding portions of the clamp members;
wherein at least one of the protruding portions is configured to be inserted into the bale to facilitate handling of the bale.

30. A bale clamp as claimed in claim 29, wherein the at least one of the protruding portions is configured to be inserted into the bale by providing a taper therein which tapers inwardly towards a distal end of the protruding portion.

31. A bale clamp as claimed in claim 29, wherein the support frame comprises a track for each support arm to facilitate the sliding movement of the support arm.

32. A bale clamp as claimed in claim 29, wherein the support arms are arranged in a single plane.

33. A bale clamp as claimed in claim 32, wherein the single plane extends generally vertically in use.

34. A bale clamp as claimed in claim 29 wherein each clamp member is actuated by a corresponding actuator.

35. A bale clamp as claimed in claim 29 wherein one or more of the clamp members comprise a plurality of protruding portions.

36. A bale clamp as claimed in claim 35 wherein each protruding portion is tapered towards a distal end.

37. A bale handling clamp, comprising:
an actuator;
at least two clamp members, each having a support arm to support and enable lateral movement of the clamp member, each support arm having a longitudinal axis along which the arm travels during such lateral movement;
wherein one or more of the clamp members comprises a protruding portion configured to be inserted into the bale to facilitate handling of the bale; and
wherein the longitudinal axis of any given arm is offset with respect to the longitudinal axis of each other arm.

38. A bale clamp as claimed in claim 37, wherein the at least one of the protruding portions is configured to be inserted into the bale by providing a taper therein which tapers inwardly towards a distal end of the protruding portion.

39. A bale clamp as claimed in claim 37 wherein one or more of the clamp members comprises a plurality of protruding portions.

40. A bale clamp as claimed in claim 39, wherein each protruding portion is tapered towards its distal end.

41. A bale clamp as claimed in claim 37, further comprising a support frame for the actuator and the support arms of the at least two clamp members, the support frame configured to support the relative movement of the clamp members.

42. A bale clamp as claimed in claim 41, wherein the support frame comprises a track for each support arm to facilitate the sliding movement of the support arm.

43. A bale clamp as claimed in claim 37, wherein the support arms are arranged in a single plane.

44. A bale clamp as claimed in claim 37 comprising a plurality of actuators, each clamp member being actuated by a corresponding actuator.

45. A bale clamp as claimed in claim 29, configured for attachment to a vehicle.

46. A method for handling a bale comprising:
inserting a protruding portion of a clamp member into the bale;
positioning the protruding portion of an opposing clamp member adjacent to a side of the bale; and
moving relatively one or more of the clamp members towards each other such that part of the bale can be secured between the protruding portions of the clamp members.

47. A method as claimed in claim 46 further comprising the step of moving the part of the bale away from the bale, once the part of the bale has been secured between the protruding portions.

48. A method as claimed in claim 46 wherein one or more of the protruding portions are tapered inwardly to a distal end thereof.
